(19) United States
(12) Patent Application Publication
(10) Pub. No.: US 2006/0153303 A1
(43) Pub. Date: Jul. 13, 2006

(54) Apparatus and method for video decoding

(76) Inventors: Jung-fu Hsu, Hsinchu (TW); Chih-ming Wang, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/179,828

(22) Filed: Jul. 11, 2005

(30) Foreign Application Priority Data
Jan. 11, 2005 (TW) 94100707

(51) Int. Cl. H04N 11/02; H04N 11/04; H04N 7/12; H04B 1/66

(52) U.S. Cl. 375/240.25; 375/240.24; 375/240.12

(57) ABSTRACT

An apparatus and method for video decoding decodes a coded video bitstream with a smaller buffer to reconstruct a sequence and outputs it for reducing cost. The apparatus comprises a decoding component, a strip buffer and an outputting component. The decoding component receives the coded video bitstream and decodes it to reconstruct a decoded picture of the sequence. The strip buffer stores a fraction of the decoded picture. The outputting component reads the strip buffer and outputs the fraction of the decoded picture sequentially.

### BACKGROUND OF THE INVENTION

a) Field of the Invention

The invention relates to an apparatus and method for video decoding, more particularly, to an apparatus and method that uses a relatively smaller buffer for video decoding.

b) Description of the Related Art

In recent years, sound and image can be stored and played in digital format due to the fast development of information technology, and thereby the application of audio/video information is extended immensely. However, a very large storage space is required if one were to store the audio/video information in full format, especially the video data that records images. To solve the problem of oversized video files, several encoding techniques have been developed to compress the size of video files and to keep the original picture quality of video files in play, or to keep the level of picture quality within an acceptable range when the video files are played. Since video is encoded for storage, it must be decoded before being played.

Hereinafter, the principle of video encoding is briefly explained by using Motion Picture Experts Group (MPEG) as an example. Primarily speaking, a sequential video coding is divided into two parts. The first one is called “intra-coding” for generating an intra picture (I picture), which can be transformed to a static picture without reference to forward or backward pictures, and require the biggest amount of data. The second part is called “inter-coding,” which is a method for predicting reconstruction pictures by using the adjacent pictures to predict the current picture. The method can generate a predicted picture (P picture) or a bi-directional predicted picture (B picture). The difference between the P and B pictures is that the P picture uses only forward prediction. That is, only the forward picture is referred for reconstructing the P picture. On the other hand, the reconstruction of the B picture uses both of the forward and backward pictures or an average of the two, and therefore has the highest efficiency for encoding. However, the B picture itself cannot be used for other prediction encoding.

FIG. 1 is used to describe video decoding, wherein the letters represent the picture type of each picture (I picture, P picture, or B picture) and the numerals represent the playing order of the sequence. As described in the aforementioned video encoding method, the reconstruction of B pictures uses both of the forward and backward pictures; thus I₀ and P₃ are needed as reference pictures to reconstruct B₁. Accordingly, Iₒ and P₃ are needed as reference pictures to reconstruct B₂, and P₃ and P₆ are needed as reference pictures to reconstruct B₄. On the other hand, the reconstruction of P₃ only need to reference to Iₒ, and accordingly, the reconstruction of P₆ only need to reference to P₃. Hence, the sequence in FIG. 1 is decoded in the following order: I₀→P₃→B₁→B₂→P₆→B₄→B₅→P₇→B₇→B₈, and the sequence is played according to the numbering in ascending order. Moreover, each picture is composed of a plurality of macroblocks, which are the smallest unit in decoding. After the pictures have been decoded and reconstructed, they are horizontally scanned before being played.

According to the video decoding method described above, a conventional video decoding device 1 as shown in FIG. 2 includes a decoding component 11, a first buffer 12, a second buffer 13, a third buffer 14, and an outputting component 15. The decoding component 11 receives a video bitstream, and then decodes it for picture reconstruction via algorithms such as variable-length decoding (VLD), inverse quantization, inverse discrete cosine transform (IDCT), and motion compensation. The first buffer 12 and the second buffer 13 store, respectively, I pictures and P pictures, which are read by the decoding component 1 as reference pictures to reconstruct B pictures, and the third buffer 14 stores the reconstructed B pictures. The outputting component 15 reads the reconstructed pictures from the first, second, and third buffers 12, 13, 14, and plays the pictures in sequence.

Nonetheless, the buffers in the conventional video decoding device 1 take up a relatively large memory space, and thereby the cost of video decoding devices cannot be lowered effectively. For example, a standard DVD image according to Phase Alternate Lines (PAL), which is adopted by most European countries and Australia, is 720×576 pixels, and each pixel is represented by 12 bits; thus the memory space required by the three buffers of the video decoding device is 720×576×12×3=14.24Mb. In addition, buffering of the video bitstream, user information, on screen display (OSD) data and such would take up some memory space, and it is obvious that one 16Mb memory placed in the electronic product would not provide sufficient memory space. On the other hand, replacing a 16Mb memory with one 32Mb or 64Mb memory would greatly increase the manufacturing cost of the video decoding device, and replacing it with two 16Mb memories would take up relatively more space besides the increase in cost, wherein the electronic product cannot be minimized in size effectively.

In view of the aforementioned, the goal is to decode video with a relatively smaller buffer so that the cost is reduced and space is saved.

### BRIEF SUMMARY OF THE INVENTION

An object of the invention is to provide an apparatus and method for video decoding that decodes video with smaller buffers such that the cost is reduced and space is saved.

The invention provides an apparatus for video decoding that includes a decoding component, a strip buffer, and an outputting component. The decoding component receives and decodes a coded video bitstream to reconstruct a decoded picture of a sequence. The strip buffer is signal-connected to the decoding component and stores a fraction of the decoded picture. The outputting component, which is signal-connected to the strip buffer, reads the strip buffer and outputs the fraction of the decoded picture sequentially.

The invention also provides a method for video decoding that includes steps of receiving and decoding a coded video bitstream for reconstructing a decoded picture of a sequence; storing a fraction of the decoded picture in a strip buffer; and reading and outputting the fraction of the decoded picture stored in the strip buffer sequentially.

The invention further provides another method for video decoding that includes steps of receiving and decoding the coded video bitstream for reconstructing a decoded picture of a sequence, wherein the decoded picture includes a reference picture and a non-reference picture; storing the reference picture in a frame buffer; storing a fraction of the non-reference picture in a strip buffer; and reading and outputting the fraction of the non-reference picture stored in the strip buffer sequentially.

The apparatus and method for video decoding of the invention outputs the non-reference picture, which is not used as reference to decode other pictures, without storing it in full format, and therefore is able to effectively reduce the memory space occupied by the buffer and saves the space occupied by the memory.

### BRIEF DESCRIPTION OF THE DRAWINGS

FIG. 1 illustrates a sequence comprising reference pictures and non-reference pictures

FIG. 2 illustrates the structure of a conventional video decoding device

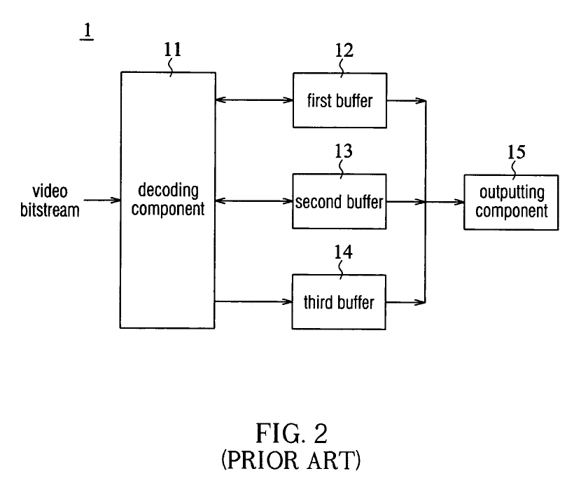

FIG. 3 illustrates the structure of a video decoding apparatus according to a preferred embodiment of the invention

FIG. 4a and FIG. 4b are schematic diagrams illustrating the accessing of strip buffers

FIG. 5 illustrates steps of a video decoding method according to a preferred embodiment of the invention.

### DETAILED DESCRIPTION OF THE INVENTION

The apparatus and method for video decoding according to preferred embodiments of the invention is described in reference to related drawings; the substantially same elements are given the same reference numerals.

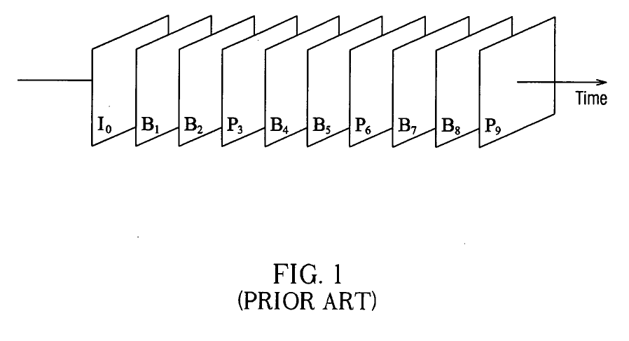

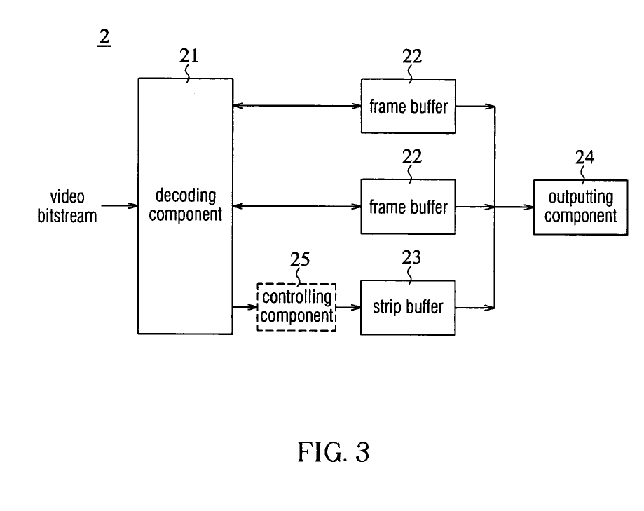

A preferred embodiment of an apparatus for video decoding 2 according to the invention is shown in FIG. 3, and the apparatus 2 is described by decoding the sequence illustrated in FIG. 1. The apparatus 2 includes a decoding component 21, two frame buffers 22, a strip buffer 23, and an outputting component 24. The decoding component 21 receives and decodes a video bitstream to reconstruct decoded pictures of a sequence. For example, in FIG. 1, a video bitstream encoded with MPEG includes I pictures, P pictures, and B pictures for better encoding efficiency, wherein the I and P pictures are further used as reference pictures for reconstructing other pictures, and the B pictures, called non-reference pictures, are not. The decoding component 21 receives the video bitstream, and decodes it for reconstruction of a sequence having I pictures, P pictures, and B pictures; the decoding order is I₀→P₃→B₁→B₂→P₆→B₄→B₅→P₉→B₇→B₈. The outputting component 24 outputs the reconstructed sequence and the playing order is I₀→B₁→B₂→P₃→B₄→B₅→P₆→B₇→B₈→P₉.

The frame buffers 22, which are signal-connected to the decoding component 21 and the outputting component 24, store I pictures or P pictures as reference pictures, from which the decoding component 21 reads to construct B pictures and the outputting component 24 reads to output I pictures and P pictures. Since I and P pictures are used as reference pictures, they must be stored in full format in the frame buffers 22. The strip buffer 23 is also signal-connected to the decoding component 21 and the outputting component 24, and stores non-reference pictures, B pictures. The pictures stored in the strip buffer 23 are not referenced to for reconstruction of other pictures and, can be erased after they have been read and output by the outputting component 24. Therefore, the strip buffer 23 does not store B pictures (non-reference pictures) in full format. Instead, a relatively smaller memory space is used to repeat the steps of storing a fraction of the decoded picture, outputting pictures, storing another fraction of the decoded picture and so on to output whole non-reference pictures.

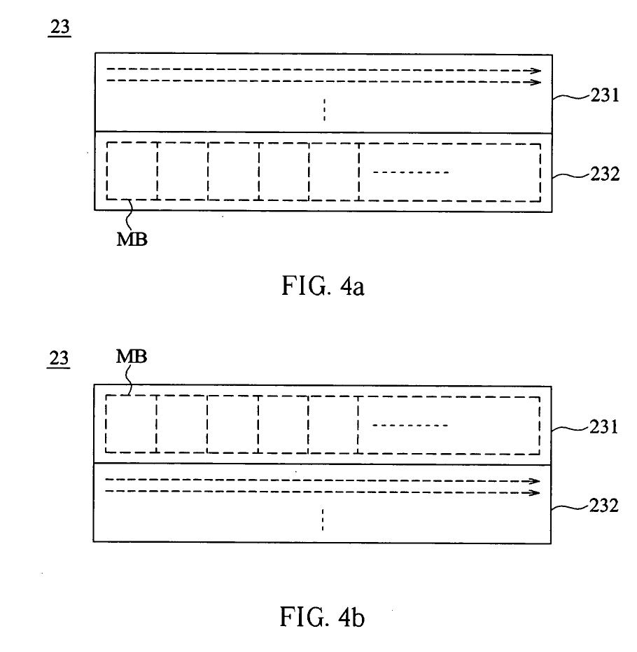

Referring to FIGS. 4a and 4b, the strip buffer 23 comprises at least two strip buffer blocks, 231 and 232. The smallest decoding unit of reconstructing a picture is a macroblock, and the output of pictures is by sequentially scanning the pictures in horizontal direction. Thus, the strip buffer blocks 231 and 232 storing a fraction of the decoded picture are at least the product of the horizontal width of decoded pictures and the vertical height of macroblocks, F_{w}×MBₕ, wherein F_{w} is the horizontal width of decoded pictures and MBₕ is the vertical height of macroblocks. For example, the storage of each strip buffer block 231, 232 that can store a fraction of a decoded picture is 720×16 pixels if the picture is of 720×576 pixels and each macroblock is of 16×16 pixels. As shown in FIG. 4a, after 45 macroblocks (720/16=45) have been decoded in the horizontal direction and written into the strip buffer block 231, the outputting component 24 sequentially scans and outputs the decoded picture, and the decoding component 21 decodes and writes the macroblocks into the strip buffer block 232. As shown in FIG. 4b, after the information in the strip buffer block 231 are completely output, the outputting component 24 continues to sequentially scan and output information in the strip buffer block 232, and the information in the strip buffer block 231 are overwritten for the decoding component 21 to continue writing in information of decoded pictures. Hence, when the decoding speed and the outputting speed cooperate with each other, the entire non-reference picture can be decoded and output.

The apparatus 2 according to a preferred embodiment of the invention further includes a controlling component 25 that is signal-connected between the decoding component 21 and the strip buffer 23. The controlling component 25 inhibits the decoding component 24 to write information into the strip buffer blocks 231, 232 that have not been read by the decoding component 24. And, after the outputting component 24 has read the strip buffer blocks 231, 232, the controlling component 25 permits the decoding component 21 to write into the strip buffer blocks 231, 232, in which the information can now be overwritten. Moreover, the outputting component 24 outputs reference pictures, I pictures and P pictures, and reads the frame buffers 22 concurrently. At the same time, the decoding component 21 can write information into the strip buffer 23, which is the strip buffer blocks 231, 232, to prevent the strip buffer 23 from being stalled, and the decoding component 21 can have sufficient time to do decoding. It is to be noted that the frame buffers 22 and the strip buffer 23 can be integrated into a conventional memory, such as random access memory (RAM), and the controlling component 25 can be integrated into the decoding component 21.

The sequence of FIG. 1, which is used as the example in the description above, includes reference pictures (I picture, P picture) and non-reference pictures (B picture) and is encoded with MPEG A person skilled in the art would know that if a sequence to be decoded does not contain reference pictures, which means a single picture is decoded without referencing to adjacent pictures, the video decoding apparatus 2 does not need the frame buffers 22 for storing the reference pictures. And, if the decoding speed cooperates with the outputting speed, the controlling component 25 is not needed for controlling which strip buffer blocks, 231 and 232, to write the decoding information into, and the apparatus 2 just has to decode and output pictures sequentially. The apparatus 2 for video decoding according to the invention can achieve the goal of minimizing space by comprising only the decoding component 21, the strip buffer 23, and the outputting component 24.

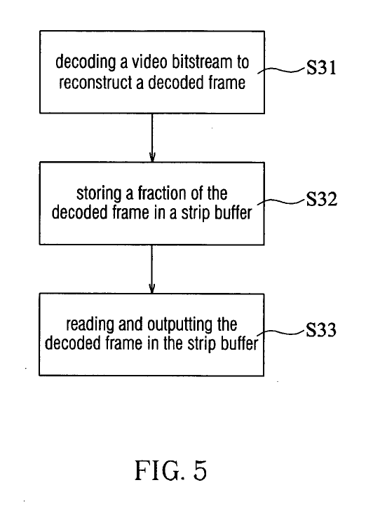

Referring to FIG. 5, the invention discloses a method for video decoding. As described above, when the sequence to be decoded doesn't contain reference picture, the method for video decoding includes steps of receiving and decoding an encoded video bitstream to reconstruct a decoded picture of the sequence (S31); storing a fraction of the decoded picture in a strip buffer 23 (S32); sequentially reading and outputting a fraction of the decoded picture in the strip buffer 23. The strip buffer 23 includes at least two strip buffer blocks 231 and 232; the method of using the strip buffer 23 to store a fraction of decoded pictures and way of reading and outputting the information therein have been described above in details, and thus is not further described here. In addition, if the sequence to be decoded contains reference pictures, the reference pictures are then stored in full format in a frame buffer 22 to be read as reference when the sequence is being decoded.

The method for video decoding further includes a controlling step (not illustrated in FIG. 5) for inhibiting storing a fraction of the decoded picture into the strip buffers 231 and 232 before the information stored therein is output, and permitting the information to be written into the strip buffers 231 and 232 thereafter. When the reference pictures stored in the frame buffers 22 are being output, a fraction of the decoded picture is being stored in the strip buffer 23.

According to the apparatus and method for video decoding disclosed by the invention, video is decoded and output by a relatively smaller buffer. Taking the sequence illustrated in FIG. 1 as an example, a conventional video decoding device would require 14.24Mb of memory space. As for the video apparatus according to the invention with two frame buffers (9.49Mb) and a strip buffer disposed therein, since the strip buffer comprises two strip buffer blocks and each strip buffer block occupies a memory space of 720×16×12=0.13Mb, the required memory space is calculated to be 9.49+0.13×2=9.75Mb. The required memory space of the video apparatus with eight strip buffers disposed therein is calculated to be only 9.49+0.13×8=10.53Mb. Therefore, the memory space occupied by the video decoding apparatus is greatly reduced. With one 16 Mb memory disposed in the video decoding apparatus, the memory space is sufficient for other information to be stored and accessed, for example, the buffering of the video bitstream, user information, OSD data and such. Hence, the memory cost can be reduced and the space occupied by a second memory is saved.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for video decoding, which decodes a coded video bitstream and reconstructs and outputs a sequence, the apparatus comprising:
a decoding component for receiving and decoding the coded video bitstream to reconstruct a decoded picture of the sequence;
a strip buffer signal-connected to the decoding component for storing a fraction of the decoded picture; and
an outputting component signal-connected to the strip buffer for sequentially reading and outputting a fraction of the decoded picture stored in the strip buffer.

2. The apparatus for video decoding as described in claim 1, wherein the strip buffer comprises a plurality of strip buffer blocks; one of the strip buffer blocks is provided for the outputting component to read and to output information, and the other strip buffer blocks are provided for the decoding component to store other fractions of the decoded picture or a next decoded picture.

3. The apparatus for video decoding as described in claim 2, wherein the decoded picture is formed by a plurality of macroblocks, and each of the strip buffer blocks stores a fraction of the decoded picture that is F_{w}×MBₕ, in which F_{w} is the horizontal width of the decoded picture and MBₕ is the vertical height of the macroblocks.

4. The apparatus for video decoding as described in claim 2, further comprising:
a controlling component signal-connected between the decoding component and the strip buffer, wherein the controlling component inhibits the decoding component to write into the strip buffer blocks before the strip buffer blocks are read by the outputting component, and permits the decoding component to write into the strip buffer blocks thereafter.

5. The apparatus for video decoding as described in claim 4, wherein the controlling component is integrated into the decoding component.

6. The apparatus for video decoding as described in claim 1, further comprising:
a frame buffer signal-connected to the decoding component and the outputting component for storing the decoded picture, wherein the decoded picture includes a reference picture and a non-reference picture, and the decoding component stores the reference picture in the frame buffer and the non-reference frame in the strip buffer.

7. The apparatus for video decoding as described in claim 6, wherein the decoded picture is formed by a plurality of macroblocks and the strip buffer comprises a plurality of strip buffer blocks, each of the strip buffer blocks stores a fraction of the decoded picture that is F_{w}×MBₕ, in which F_{w} is the horizontal width of the decoded picture and MBₕ is the vertical height of the macroblocks.

8. The apparatus for video decoding as described in claim 6, further comprising:
a controlling component signal-connected between the decoding component and the strip buffer, wherein the controlling component inhibits the decoding component to write into the strip buffer blocks before the strip buffer blocks are read by the outputting component, and permits the decoding component to write into the strip buffer block thereafter.

9. The apparatus for video decoding as described in claim 8, wherein the controlling component is integrated into the decoding component.

10. The apparatus for video decoding as described in claim 6, wherein the strip buffer and the frame buffer are integrated into a memory.

11. The apparatus for video decoding as described in claim 10, wherein the memory is a random access memory.

12. The apparatus for video decoding as described in claim 1, wherein the coded video bitstream is coded with MPEG.

13. A method for video decoding, which decodes a coded video bitstream and reconstructs and outputs a sequence, the method comprising:
receiving and decoding the coded video bitstream to reconstruct a decoded picture of the sequence;
storing a fraction of the decoded picture in a strip buffer; and reading and outputting in sequence a fraction of the decoded picture in the strip buffer.

14. The method for video decoding as described in claim 13, wherein the strip buffer comprises a plurality of strip buffer blocks; one of the strip buffer blocks is provided for the outputting component to read and to output information, and the other strip buffer blocks are provided for the decoding component to store other fractions of the decoded picture or next decoded picture.

15. The method for video decoding as described in claim 14, wherein the decoded picture is formed by a plurality of macroblocks, and each of the strip buffer blocks stores a fraction of the decoded picture that is F_{w}×MBₕ, in which F_{w} is the horizontal width of the decoded picture and MBₕ is the vertical height of the macroblocks.

16. The method for video decoding as described in claim 14, further comprising:
a controlling step to inhibit storing a fraction of the decoded picture in the strip buffer blocks before the information in the strip buffer blocks is output, and to permit storing in the strip buffer blocks thereafter.

17. The method for video decoding as described in claim 13, wherein the coded video bitstream is coded with MPEG.

18. A method for video decoding, which decodes a coded video bitstream and reconstructs and outputs a sequence, the method comprising:
receiving and decoding the coded video bitstream to reconstruct a decoded picture of the sequence, the decoded picture comprising a reference picture and a non-reference picture;
storing the reference picture in a frame buffer;
storing a fraction of the non-reference picture in a strip buffer; and
reading and outputting in sequence a fraction of the non-reference picture in the strip buffer.

19. The method for video decoding as described in claim 18, wherein the decoded picture is formed by a plurality of macroblocks and the strip buffer comprises a plurality of strip buffer blocks, each of the strip buffer blocks stores a fraction of the decoded picture that is F_{w}×MBₕ, in which F_{w} is the horizontal width of the decoded picture and MBₕ is the vertical height of the macroblocks.

20. The method for video decoding as described in claim 18, further comprising:
a controlling step to inhibit storing a fraction of the decoded picture in the strip buffer blocks before the information in the strip buffer blocks is output and to permit storing in the strip buffer block thereafter.

21. The method for video decoding as described in claim 18, wherein the strip buffer and the picture buffer are integrated into a memory.

22. The method for video decoding as described in claim 21, wherein the memory is a random access memory.

23. The method for video decoding as described in claim 18, wherein the coded video bitstream is coded with MPEG.
